(19) United States
(12) Patent Application Publication
(10) Pub. No.: US 2024/0281902 A1
(43) Pub. Date: Aug. 22, 2024

(54) SOCIAL MEDIA SYSTEM FOR DETECTING, TRACKING, CREATING, AND UPDATING USER ACTIVITIES AND EVENTS

(71) Applicant: Abdulla Abdulsalam Z A Alyafei, Doha (QA)

(72) Inventor: Abdulla Abdulsalam Z A Alyafei, Doha (QA)

(21) Appl. No.: 18/583,226

(22) Filed: Feb. 21, 2024

Related U.S. Application Data
(60) Provisional application No. 63/486,055, filed on Feb. 21, 2023.

(51) Int. Cl. G06Q 50/00; H04L 67/1396; H04L 67/306

(52) U.S. Cl. CPC G06Q 50/01; H04L 67/1396; H04L 67/306

(57) ABSTRACT

A system includes a first client device, a second client device, and one or more additional client devices. The system includes a server device communicably coupled to a plurality of client devices and configured to process various forms of shared data, the plurality of client devices comprising the first client device, the second client device, and the one or more additional client devices. The server device is further configured to determine a second client device status and one or more additional client device statuses and communicate at least one of the first client user events to the second client device and one or more additional client devices.

### CROSS-REFERENCE TO RELATED APPLICATIONS

This application claims the benefit of priority of U.S. provisional application No. 63/486,055, filed Feb. 21, 2023, the entire contents of which are herein incorporated by reference.

### FIELD

The present disclosure relates to network communications.

### BACKGROUND

Social networking applications have become an integral part of the Internet, and the aggregated and shared communications data permeating from these social networking applications have improved the Internet by expanding its overall functionality and efficiency. However, there are technical limitations of these applications when it comes to aggregated and shared communications.

### SUMMARY

In one aspect of the present disclosure, a system includes a first client device configured to detect first client user activities, create first client user events based on detected first client user activities, and share the first client user events. The system includes a second client device configured to detect second client user activities, create second client user events based on detected second client user activities, and share the second client user events. The system includes one or more additional client devices configured to detect one or more additional user activities, create one or more additional client user events based on detected one or more additional user activities, and share the one or more client user events. The system includes a server device communicably coupled to a plurality of client devices and configured to process various forms of shared data, the plurality of client devices comprising the first client device, the second client device, and the one or more additional client devices. The server device is further configured to determine a second client device status and one or more additional client device statuses and communicate at least one of the first client user events to the second client device and one or more additional client devices.

### BRIEF DESCRIPTION OF THE DRAWINGS

FIG. 1 is a diagram of a scheduling system for detecting, tracking, creating, and updating user activities and events, according to aspects of the present disclosure;

FIG. 2 is flow diagram of a computer algorithm for detecting, tracking, creating, and updating user activities and events, according to aspects of the present disclosure; and

FIGS. 3A-3D are diagrams of user interfaces for joining an event, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, social networking applications lack event processing and calendar features thereby limiting the effectiveness of the Internet as a social networking tool for sharing diverse sets of Internet communications data. More specifically, social networking applications lack functional components capable of monitoring and sensing user activities, identifying potential user events, creating user events, creating user event invites, posting user event invites, joining user-posted event invites, tracking event invites, discovering event invites, and calendarizing event invites.

Broadly, an embodiment of the present disclosure provides a scheduling system comprising a social networking application configured to process various forms of Internet communications and in-process data. The scheduling system allows a user to create user events, user join, and user location data. The scheduling system allows a user to create calendar data comprising user event information, user join information, and user location information. The scheduling system allows a user to track user events, user join, and user location data. The scheduling system allows a user to communicate user events, user joins, and user location data to relevant user applications of the social networking application. The social networking application is configured to monitor and sense user activities, identify user events, create user events, create user event invites, post user event invites, join user posted event invites, track event invites, discover event invites, share location information, update event invites, and calendarize event invites.

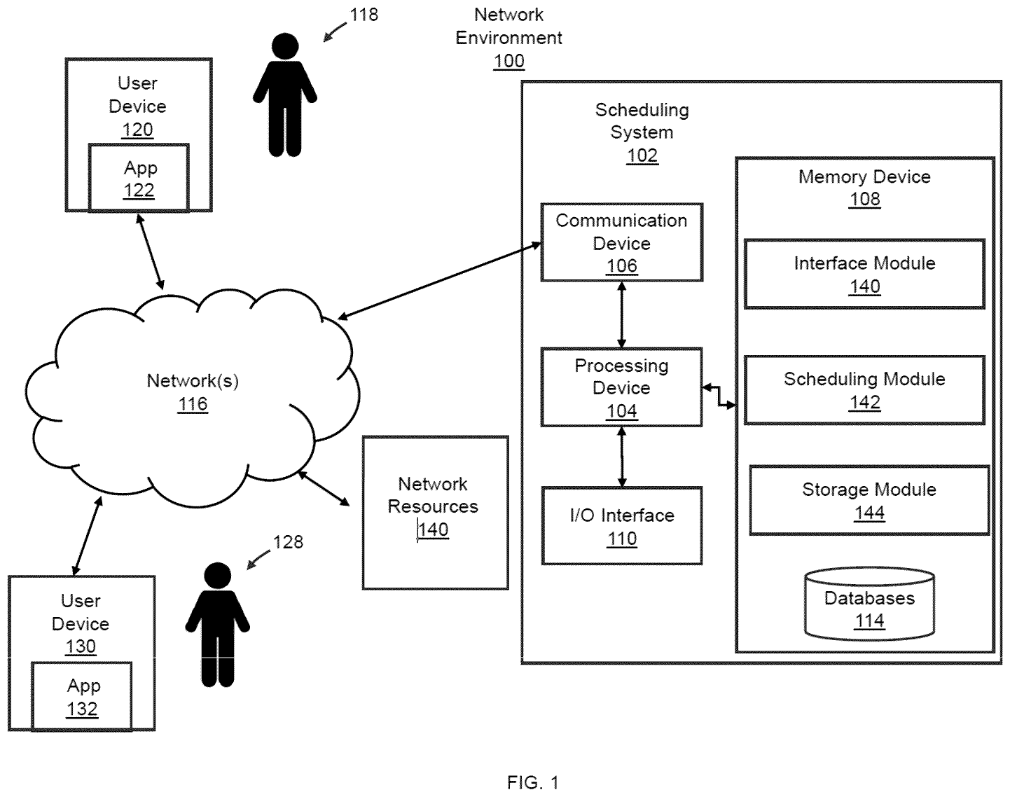

Referring now to FIGS. 1, 2, and 3A-3D, FIG. 1 illustrates a scheduling system 102, according to aspects of the present disclosure. While FIG. 1 illustrates examples of components of the scheduling system 102, additional components can be added, and existing components can be removed and/or modified.

As illustrated in FIG. 1, the scheduling system 102 includes a processing device 104 coupled to a communication device 106. The processing device 104 is also coupled to a memory device 108, and an input/output (“I/O”) interface 110. In embodiments, the communication interface 104 enables the scheduling system 102 to communicate with other devices and systems via one or more networks 116. The scheduling system 102 can communicate with a user 118, operating a user device 120, via the network 116, and a user 128, operating a user device 130, via the network 116. The user device 120 and/or the user device 130 can include one or more electronic devices such as a laptop computer, a desktop computer, a tablet computer, a smartphone, a thin client, and the like.

The scheduling system 102 is configured to process various forms of Internet communications and in-process data to operate and manage a social network by communicating with one or more user devices, e.g., the user device 120 and the user device 130. The scheduling system 102 can communicate with a social networking application. The scheduling system 102 and the social networking application allow a user (e.g., the user 118 and/or the user 128) to create user events, user join, and user location data. The scheduling system 102 and the social networking application allow a user to create calendar data comprising user event information, user join information, and user location information. The scheduling system 102 and the social networking application allow a user to track user events, user join, and user location data. The scheduling system 102 and the social networking application allow a user to communicate user events, user joins, and user location data to relevant user applications of the social networking application. The scheduling system 102 and the social networking application allow a user to monitor and sense user activities, identify user events, create user events, create user event invites, post user event invites, join user-posted event invites, track event invites, discover event invites, share location information, update event invites, and calendarize event invites. The scheduling system 102 and the social networking application are configured to monitor and sense user activities, identify user events, create user events, create user event invites, post user event invites, join user posted event invites, track event invites, discover event invites, share location information, update event invites, and calendarize event invites.

According to the aspects of the present disclosure, the user device 120 can store and execute a copy 122 of the social networking application (hereinafter app 122). Likewise, the user device 120 can store and execute a copy 132 of the social networking application (hereinafter app 132). The app 122 enables the user 118, operating the user device 120, to join and interact with the social media network. The app 132 enables the user 128, operating the user device 130, to join and interact with the social media network. In some embodiments, the social networking application can be a specifically designed application that operates with the scheduling system 102 to perform the processes and methods described herein. In some embodiments, the app 122 and/or the app 132 can be a third-party application, such as a web browser, that communicates with the scheduling system 102, implementing aspects of the social networking application, to perform the processes and methods described herein.

To perform the process described herein, the scheduling system 102 can store and execute an interface module 140, a scheduling module 142, and a storage module 144 to perform the processes and methods described herein. The interface module 140, the scheduling module 142, and the interface module 144 can be stored in the memory device 108. The app 122, the app 132, the interface module 140, the scheduling module 142, and the interface module 144 can include the necessary logic, instructions, and/or programming to perform the processes and methods described herein. The app 122, the app 132, the interface module 140, the scheduling module 142, and the interface module 144 can be written in any programming language.

The memory device 108 can also include a database 114 that stores information and data associated with the process and methods described herein. The database 114 can store data associated with the operation of the social media network. The storage module 144 can be configured to manage the database 114, store data in the database 114, and retrieve data from the database 114. The database 114 can be any type of database, for example, a hierarchical database, a network database, an object-oriented database, a relational database, a non-relational database, an operational database, and the like. The term data, as used herein, means a variable comprising a parameter and a value. The term user activity, as used herein, can mean, as an example, activities related to a user accessing an application or an application feature, user generated communications, and contents of a user generated communication. User as used herein can mean an event inviter and an event invitee. The term event inviter and event invitee can refer to a person or a business entity. The term user event, as used herein, can include, as an example, itinerary information, booking information, ticketing information, advertisement information, social gathering information, and itineraries. The term user event, as used herein, can relate to a public or private event. User events can be personal related, business related, government related, or any combination thereof. Internet communications data, as used herein, can mean, for example, personal and business-related instant message, video, web (http/https), VoIP, SQL (Structured Query Language), and Customer Resource Management (CRM) data.

The interface module 140 operates to generate and provide graphical user interfaces (GUIs) to the application 122, for example, menus, widgets, text, images, fields, etc. Additionally, the interface module 140 can provide data to the application 122, and the application 122 can generate GUIs. The GUIs generated by the interface module 140 and/or the application 122 can be interactive. For example, the GUIs can allow the user 118 of the user devices 120 to interact with the social network and the scheduling system 102.

The processing device 104, the communication device 106, the memory device 108, and the I/O interface 110 can be interconnected via a system bus. The system bus can be and/or include a control bus, a data bus, an address bus, and the like. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the scheduling system 102 can include multiple processing devices 104, whether the same type or different types.

The memory device 108 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 108. While FIG. 1 illustrates a single memory device 108, the scheduling system 102 can include multiple memory devices 108, whether the same type or different types.

The communication device 104 enables the scheduling system 102 to communicate with other devices and systems. The communication device 104 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The scheduling system 102 can communicate with one or more network resources via the network 116. The one or more network resources 140 can include external websites, external databases, social media platforms, search engines, file servers, web servers, or any type of computerized resource that can communicate with the scheduling system 102 via the network 116.

In embodiments, the components and functionality of the scheduling system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the scheduling system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the scheduling system 102 and the user device 120 can include a user interface for outputting information in a format perceptible by a user and receiving input from the user. For example, the scheduling system 102 can communicate with the user interface via the I/O interface 112. In another example, the user device 120 can include the user interface for providing information to and receiving information from the user 118. In another example, the user device 130 can include a user interface for providing information to and receiving information from the user 128. The user interface can display graphical user interfaces (“GUIs”) generated by the scheduling system 102, the app 122, and/or the app 132. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

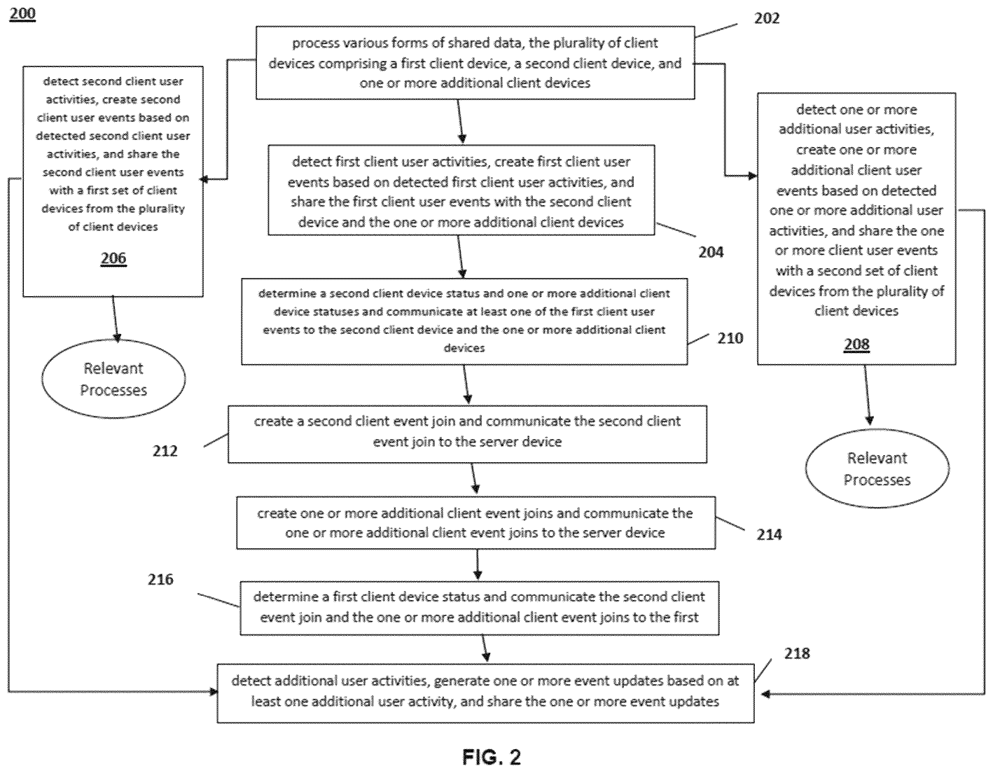

Referring now to FIG. 2, illustrated is a flow diagram of a computer algorithm 200 for detecting, tracking, creating, and updating user activities and events, in accordance with embodiments of the present disclosure. The algorithms can be encoded in the modules of the scheduling system and/or the social networking application.

At block 202, the computer algorithm 200 processes various forms of shared data, the plurality of client devices comprising a first client device, a second client device, and one or more additional client devices. For example, the computer algorithm 200 can process data from the user device 120 and/or the user device 130.

At block 204, the computer algorithm 200 detects first client user activities, creates first client user events based on detected first client user activities, and shares the first client user events with the second client device and the one or more additional client devices. For example, the computer algorithm 200 can detect activities of the user device 120.

At block 206, the computer algorithm 200 detects second client user activities, create second client user events based on detected second client user activities, and share the second client user events with a first set of client devices from the plurality of client devices. For example, the computer algorithm 200 can detect activities of the user device 130. The computer algorithm 200 can then proceed to relevant processes that are like the processes to be described in blocks 210-218.

At block 208, the computer algorithm 200 detects one or more additional user activities, creates one or more additional client user events based on detected one or more additional user activities, and shares the one or more client user events with a second set of client devices from the plurality of client devices. For example, the computer algorithm 200 can detect activities of other user devices communicating with the scheduling system 102 and/or the network resources 140. The computer algorithm 200 can then proceed to relevant processes that are like the processes to be described in blocks 210-218.

At block 210, the computer algorithm 200 determines a second client device status and one or more additional client device statuses and communicate at least one of the first client user events to the second client device and the one or more additional client devices. At block 212, the computer algorithm 200 creates a second client event join and communicates the second client event join to the server device. At block 214, the computer algorithm 200 creates one or more additional client event joins and communicates the one or more additional client event joins to the server device. At block 216, the computer algorithm 200 determines a first client device status and communicates the second client event join, and one or more additional client event joins to the first client device. At block 218, the computer algorithm 200 detects additional user activities, generates one or more event updates based on at least one additional user activity, and shares the one or more event updates.

For example, in a practical application, a social networking application is instantiated on a server device, e.g., the scheduling system 102, and a plurality of user devices, e.g., the user device 120, the user device 130, etc. An inviter user device performs various activities using application functions of the social networking application. The inviter user device senses the various activities and identifies one or more of events based on the various activities. The inviter user device creates one or more actionable events addressed to one or more invitee user devices and communicates the one or more actionable events to the server device. The server device processes and communicates the one or more actionable events and communicates the one or more actionable events to the one or more invitee user devices. The one or more invitee user devices processes the one or more actionable events and communicates one or more response actionable items.

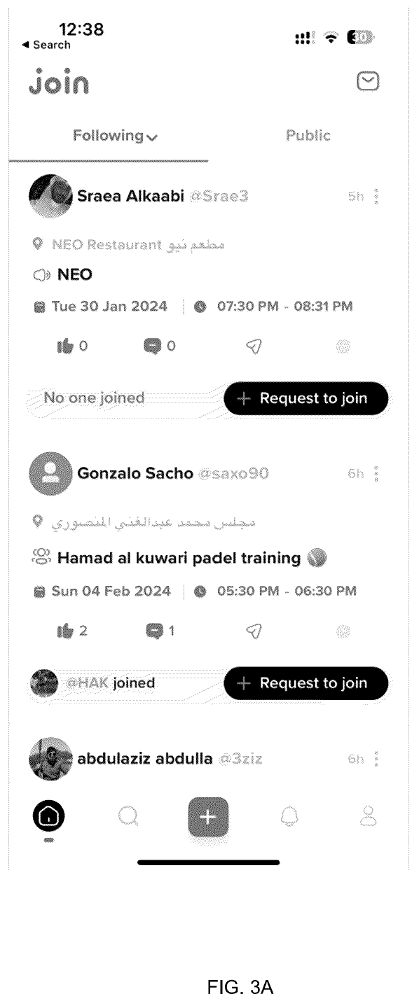

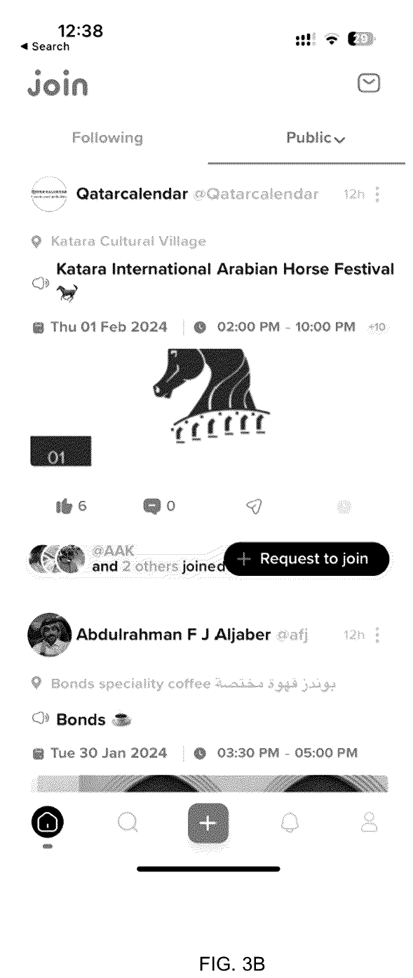

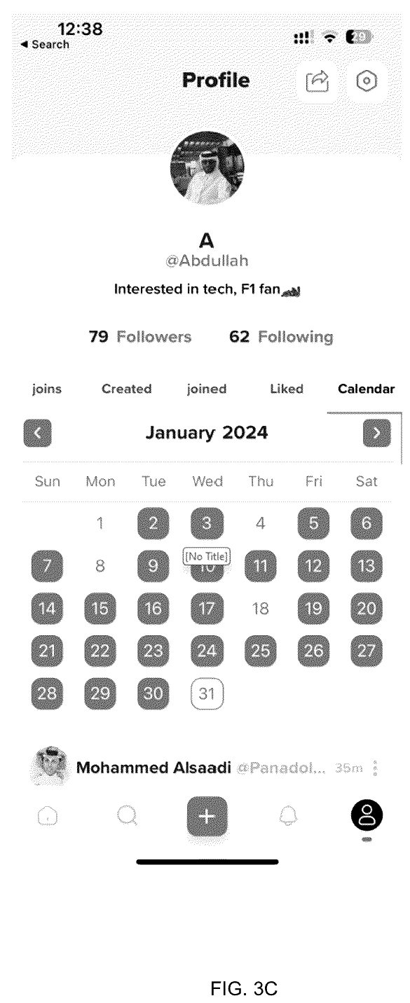

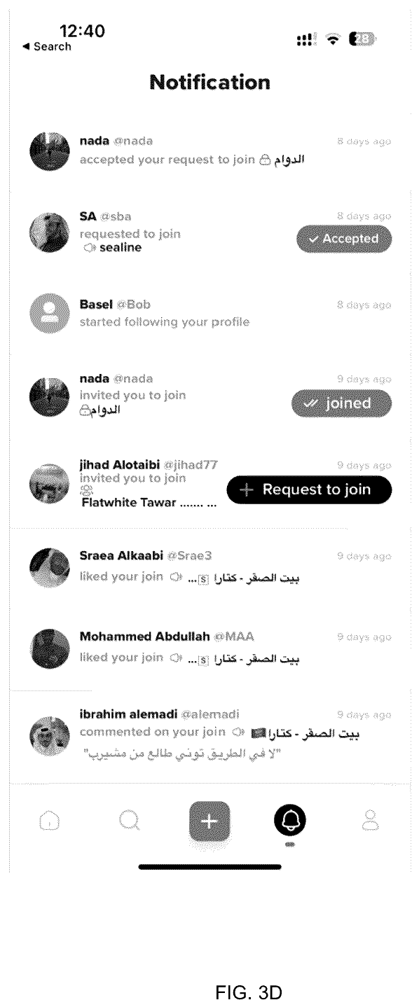

For example, as illustrated in FIGS. 3A-3B, the scheduling system 102 and/or the social networking application (e.g., the app 122, the app 132) generate one or more GUIs for interacting with the social network. In embodiments, the social networking application enables users to:—post and follow a “join;”—a “join” is a status wherein the event or activity is detailed by the user(s) with the inclusion of location, calendar, and timing features;—users are able to invite others (users, companies, entities) to their “join;”—users are either individuals, companies, or government entities. The social networking application enables individuals to build their personal profiles (define categories of interest, share current physical location), follow other individuals and companies/entities, and create “joins” (automatically displayed in a calendar format in their profile to allow all other users to follow their past and upcoming daily activities and events).

In embodiments, the social networking application enables companies/Entities to build their corporate profile, follow individuals and other companies/entities, and create “joins” (automatically displayed in a calendar format in their profile to allow all other users to follow their past and upcoming events).

In embodiments, the social networking application enables JOIN TYPES—a “join” 15 could be displayed publicly, privately (to selected individuals), or to friends (to those who follow a user's profile). For example, for private, “join” that is set to be seen only by the creator and other user(s) that the creator has opted to invite. For friends, a “join” that is set to be seen by the creator and other user(s) who follow the creator and those (not following) within the platform with a Join account (by visiting user's profile page). For public, a “join” that is set to be seen and joined by anyone in the platform (explore feed section).

In embodiments, the social networking application combines join and calendar features. The “join” is a post (described previously) designed to share what/when/where users are up to. The social networking application automatically displays the joins in a calendar format in their profile to allow all other users to follow their past and upcoming daily activities and events.

In embodiments, the social networking application is an improvement over currently available social networking technology. The social networking application uses a join to share what/where/when information about a user, business, or entity, such as a government bureaucracy. The social networking application allows Individuals to build their personal profiles (define categories of interest, share current physical location), follow other individuals and companies/entities, and create “joins.”

In embodiments, the social networking application allows companies/entities to build their corporate profile, follow individuals and other companies/entities, and create “joins” automatically displayed in a calendar format in their profile to allow all other users to follow their past and upcoming events).

In one example, using the algorithm 200, the scheduling system 102 is further configured to determine the status of one or more user (client) devices, such as user device 120 and/or user device 130. The scheduling system 102 can be configured to determine a first device client status, a second client device status, a third client device status, a status for each device in the first set of client devices, and a status for each client device in the second set of client devices, and communicate at least one client device status selected from a group consisting of the first device client status, the second client device status, the third client device status, client device status for at least one client device selected from the first set of client devices, and client device status for at least one selected from a group consisting of the second set of client devices to at least one client device selected from a group consisting of the first client device, the second client device, the third client device, at least one client device selected from the first set of client devices, and at least one client device selected from the second set of client devices.

The second client device is further configured to create a second client event join and communicate the second client event join to the scheduling system 102. The third client device 106 is further configured to create a third client event join and communicate the third client event join to the scheduling system 102. The first set of client devices and the second set of client device are further configured to create one or more additional client event joins and communicate the one or more additional client event joins to the scheduling system 102. The scheduling system 102 is further configured to determine the first client device status and communicate the second client event join and the one or more additional client event joins to the first client device.

At least one selected from a group consisting of the first client device, the second client device, at least one client device selected from the first set of client devices, and at least one client device selected from the second set of client devices are further configured to detect additional user activities, generate one or more event updates based on at least one additional user activity, and share the one or more event updates.

The first client device is configured to detect first client user activities, create first client user events based on detected first client user activities, and share the first client user events with the second client device, the third client device, and at least one client device selected the first set of client devices, and at least one client device selected from the second set of client devices.

The second client device is configured to detect second client user activities, create second client user events based on detected second client user activities, and share the second client user events with at least one client device selected from the first set of client devices, at least one client device selected from the second set of client devices, or a combination thereof.

Each client device of the first set of client devices is configured to detect one or more additional user activities, create one or more additional client user events based on detecting one or more additional user activities, and share the one or more client user events with at least one client device selected from a group consisting of the first client device, the second client device, the third client device 108, and the second set of client devices.

Each client device of the second set of client devices is configured to detect one or more additional user activities, create one or more additional client user events based on detected one or more additional user activities, and share the one or more client user events with at least one client device selected from a group consisting of the first client device, the second client device, the third client device 108, and the first set of client devices.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A system comprising:
a first client device configured to detect first client user activities, create first client user events based on detected first client user activities, and share the first client user events;
a second client device configured to detect second client user activities, create second client user events based on detected second client user activities, and share the second client user events;
one or more additional client devices configured to detect one or more additional user activities, create one or more additional client user events based on detected one or more additional user activities, and share the one or more client user events; and
a server device communicably coupled to a plurality of client devices and configured to process various forms of shared data, the plurality of client devices comprising the first client device, the second client device, and the one or more additional client devices, wherein the server device is further configured to:
determine a second client device status and one or more additional client device statuses and communicate at least one of the first client user events to the second client device and the one or more additional client devices.

2. The system of claim 1, wherein the first client device is configured to share the first client user events with the second client device and the one or more additional client device.

3. The system of claim 1, wherein the second client device is configured to share the second client user events with a first set of client devices from the plurality of client devices.

4. The system of claim 1, wherein the one or more additional client devices is configured to share the one or more client user events with a second set of client devices from the plurality of client devices.

5. The system of claim 1, wherein the second client device is further configured to create a second client event join and communicate the second client event join to the server device.

6. The system of claim 5, wherein the one or more additional client devices are further configured to create one or more additional client event joins and communicate the one or more additional client event joins to the server device.

7. The system of claim 6, wherein the server device is further configured to determine a first client device status and communicate the second client event join and the one or more additional client event joins to the first client device.

8. The system of claim 1, wherein at least one selected from a group consisting of the first client device, the second client device, and the one or more additional client devices further configured to detect additional user activities, generate one or more event updates based on at least one additional user activity, and share the one or more event updates.

9. The system of claim 1, wherein the server device is further configured to classify the first client device and the second client device in a private group.
